(19) United States
(12) Patent Application Publication
(10) Pub. No.: US 2010/0158459 A1
(43) Pub. Date: Jun. 24, 2010

(54) Long Lifetime Optical Fiber and Method

(76) Inventor: Daniel Homa, Blacksburg, VA (US)

Correspondence Address: R. PERRY MCCONNELL, P.C., 9001 FOREST CROSSING, SUITE F, THE WOODLANDS, TX, 77381, US

(21) Appl. No.: 12/343,872

(22) Filed: Dec. 24, 2008

(51) Int. Cl. G02B 6/02; B29D 11/00

(52) U.S. Cl. 385/123; 264/1.24

(57) ABSTRACT

A fiber optic construction is described combining low OH (preferably <1 ppm) materials for use in the core and cladding elements with controlled Dₒ/d ratios to provide extended life expectancy fiber optics for use in high-temperature environments.

### FIELD OF THE INVENTION

The invention relates to the making of optical fibers with extended life expectancies in high-temperature environments.

### BACKGROUND OF THE INVENTION

Optical fibers provide excellent, low-loss media for data transmission, and are used in thousands of applications. However, even though such fibers are low-loss, they are not perfect, and physical factors can limit both their transmission capabilities and their lifetimes.

It is well understood that hydroxyl ion (OH) concentration in the core and the cladding of an optical fiber affects the transmittance of the fiber, and that these effects are both wavelength- and intensity-specific. Conventional construction of fiber optics for telecom applications involved depositing a low OH cladding material on the inside of a deposition tube, so that when the tube was collapsed and the fiber pulled, the light-transmitting core would be “insulated” somewhat from the high-OH densities in the substrate tube by the thickness of the cladding.

Other processes also seek to limit the OH concentration in the core. For example, U.S. Pat. No. 6,131,415 to Chang, et al. discloses a method of controlling OH concentration to make a single-mode fiber optic with good transmittance at 1385 nm. Similarly, United States Patent Application Publication 20060204193 (Okada, et al.) discloses a method of forming an optical fiber with the goal of reducing exposure to hydrogen during the formation process, to minimize the formation of OH groups in the fiber material.

Concerns with OH concentration in optical fibers are increased when the optical fiber must be used in a high-temperature (>100° C.) environment, such as in downhole oilwell applications. Because the temperatures in a wellbore can be very high, fiber-optic lifetimes can decrease rapidly. In these high temperature environments, the OH ions in the fiber optic core and cladding material can migrate more easily than at lower temperatures. Thus, even a core material that was originally a low-OH material may be subject to a rapidly increasing OH concentration as OH ions migrate from the cladding. This increase in OH concentration in the core reduces transmittance, ultimately destroying the utility of the fiber optic.

Due to the high temperatures in wellbore environments, conventional fiber optic constructions may have lifetimes measured in days. The high costs associated with removing tools from well bores, repairing or replacing them, and re-inserting the tools downhole make such limited lifetimes undesirable. Accordingly, it is a goal of the invention to provide a fiber optic with an extended life expectancy in high temperature environments.

### SUMMARY OF THE INVENTION

The invention combines control of the cladding/core (Dₒ/d) ratio and the OH ion concentration in the core and cladding materials to provide a fiber optic with enhanced life expectancies in high temperature environments. Specifically, a preferred embodiment of the invention comprises a fiber optic with a Dₒ/d ratio of 7.5 or greater in which the entire fiber structure comprises low OH (<1 ppm) fused silica glass. Accordingly, as used herein, the term “low OH glass” refers to a fused silica glass with an OH concentration of less than 1 ppm. Those of skill in the art will recognize that a lower concentration, such as less than 10 parts per billion (“ppb”) would be even more desirable.

Other factors will be understood to further control the rate of degradation of the fiber optic. The Dₒ/d ratio can additionally be increased within practical limits to limit the rate of OH migration to the core. Because not all OH ions will migrate to the core, the rate of loss of functionality will reflect an increase in OH concentration in the core that is less than the concentration in the surrounding material.

Control of OH concentration in the fused silica glass, the Dₒ/d ratio of the fiber optic, and knowledge of the rate of migratory drift of the OH ions at given temperatures allows determination of the life expectancy of the fiber optic. In practice, then, it is possible to build a fiber optic for a particular application as inexpensively as possible, because the fiber optic need not be excessively over-engineered for a particular application.

### BRIEF DESCRIPTION OF THE DRAWINGS

FIG. 1 is a cut-away view of an optical fiber of an embodiment of the present invention.

FIG. 2 is a graphical representation of life expectancies of optical fibers of the present invention.

### DETAILED DESCRIPTION

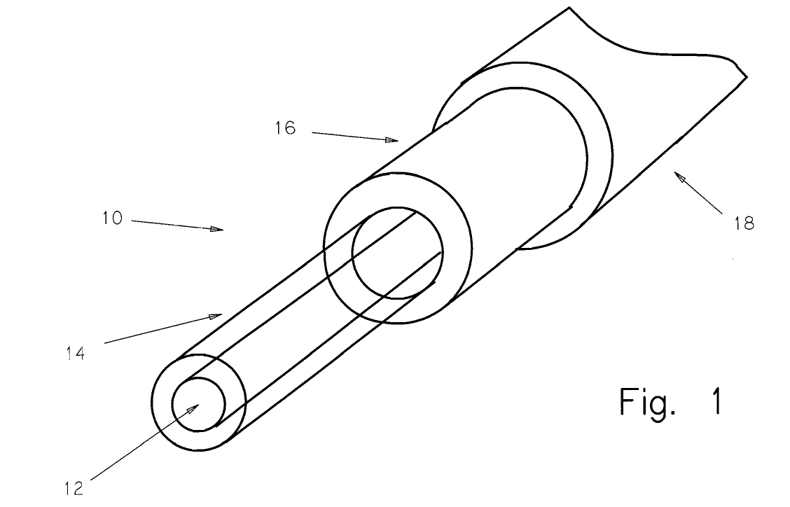

Referring to FIG. 1, a cut-away view of an optical fiber is shown. Optical fiber 10 comprises a low OH fused silica core 12 and low OH fused silica cladding 14, covered by a first protective layer 16 and, if desired, a second protective layer 18. Those of skill in the art will recognize that as optical fiber 10 is manufactured by pulling from a preform (not shown), the Dₒ/d ratio of the cladding 14 to the core 12 is set by appropriate manufacture of the preform.

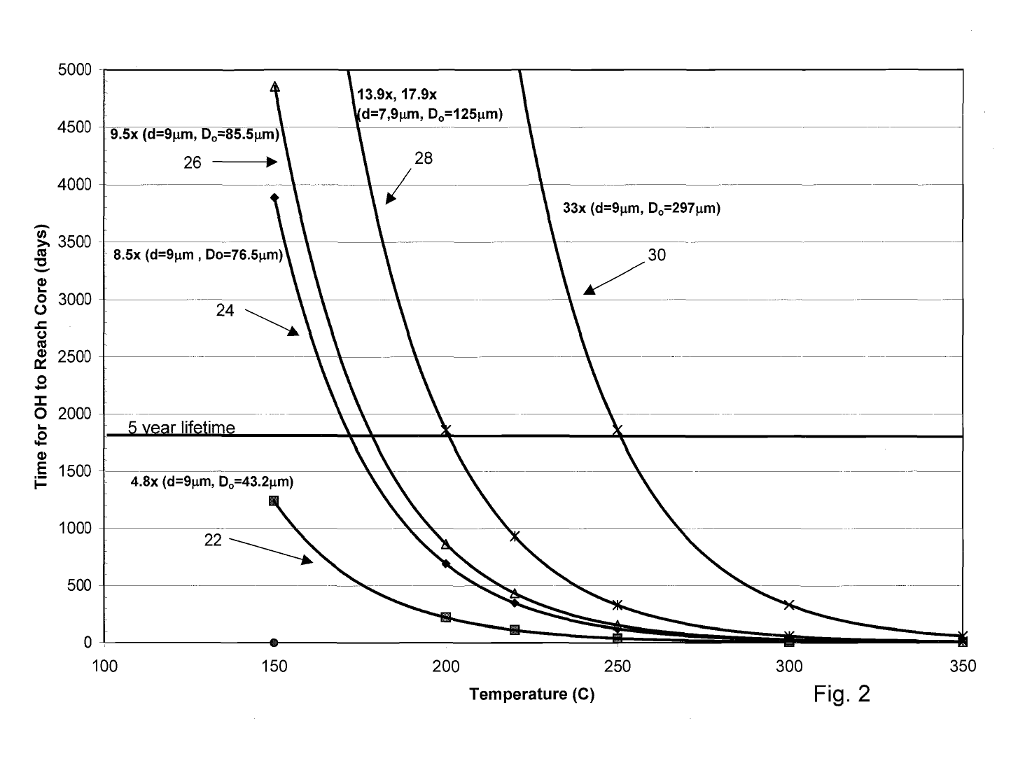

Referring to FIG. 2, a example of setting criteria for a fiber optic of the present invention is graphically portrayed as a function of operating environment temperature in degrees Celsius along the X-axis and life expectancy of the device in days along the Y-axis. As is shown in FIG. 2, example curve 22 shows the life expectancy in days of a low OH fiber optic with a Dₒ/d ratio of 4.8 at various operating temperatures, and demonstrates that if, for example, a five year lifetime is desired for the device, the Dₒ/d ratio of 4.8 is inadequate, even a the relatively low temperature of 150° C. Similarly, example curve 24 shows life expectancy as a function of operating temperature for a fiber optic with a Dₒ/d ratio of 8.5, curve 26 for a fiber optic with a Dₒ/d ratio of 9.5, curve 28 for a fiber optic with a Dₒ/d ratio of 13.9, and curve 30 for a fiber optic with a Dₒ/d ratio of 33.3. As curve 30 reflects, maintaining the fiber optic at 250° C. for five years would require a Dₒ/d ratio of over 33.

As those of skill in the art will recognize, by preselecting conditions and the desired life expectancy of the device, a preform can be constructed to provide the necessary Dₒ/d ratio, precluding the expense of unnecessary materials and processing. Further, life expectancy for the resulting fiber optic can be set, within the limits of the materials, to any desired period, for example one, two, three, four, or five years.

I claim:

1. A fiber optic device, comprising
a cylindrical core comprising low OH fused silica, and
a cylindrical cladding layer comprising low OH fused silica concentric with said core, wherein the ratio of the diameter of said cladding layer to the diameter of said core layer is greater than 7.5.

2. The fiber optic of claim 1, wherein the ratio of the diameter of said cladding layer to the diameter of said core layer provides a life expectancy for the device of at least one year.

3. The fiber optic of claim 2, wherein the ratio of the diameter of said cladding layer to the diameter of said core layer provides a life expectancy for the device of at least two years.

4. The fiber optic of claim 2, wherein the ratio of the diameter of said cladding layer to the diameter of said core layer provides a life expectancy for the device of at least three years.

5. The fiber optic of claim 2, wherein the ratio of the diameter of said cladding layer to the diameter of said core layer provides a life expectancy for the device of at least four years.

6. The fiber optic of claim 2, wherein the ratio of the diameter of said cladding layer to the diameter of said core layer provides a life expectancy for the device of at least five years.

7. The fiber optic of claim 1, wherein the OH concentration is less than 10 ppb.

8. The fiber optic of claim 2, wherein the OH concentration is less than 10 ppb.

9. A method of manufacturing a fiber optic for use at temperatures over 100° C., comprising the steps of,
selecting a desired life expectancy for said fiber optic,
determining the Dₒ/d ratio required to provide the desired life expectancy,
forming a preform comprising low OH silica, wherein said preform correlates to the desired Dₒ/d ratio, and
pulling a fiber optic from said preform.

10. The method of claim 9, wherein said Dₒ/d ratio is greater than 7.5.

11. The method of claim 9, wherein said Dₒ/d ratio is at least 13.9.
